(19) United States
(12) Patent Application Publication
(10) Pub. No.: US 2016/0230431 A1
(43) Pub. Date: Aug. 11, 2016

(54) SUPPLEMENTAL LOCKING SYSTEM

(71) Applicant: George Yonekura, San Jose, CA (US)

(72) Inventor: George Yonekura, San Jose, CA (US)

(21) Appl. No.: 14/617,725

(22) Filed: Feb. 9, 2015

(51) Int. Cl. E05C 1/02

(52) U.S. Cl. CPC E05C 1/02

(57) ABSTRACT

A supplemental locking system comprises a mountable bracket for a door, a deadbolt housing and a deadbolt. The deadbolt housing and deadbolt are quickly coupled with a locking bracket and the deadbolt is movable to a lock position in one easy and quick movement. The deadbolt housing and deadbolt are able to be stored separately from the locking bracket so that the door is unable to be inadvertently locked. Then in the event of a lockdown or other emergency where it is necessary to lock the door, it is easy to couple the deadbolt housing and deadbolt to the locking bracket and move the deadbolt to a lock position in order to secure the door from the inside.

### FIELD OF THE INVENTION

The present invention is generally directed to locking systems and devices. More specifically, the present invention is directed to a supplemental locking system for use during an emergency event.

### BACKGROUND OF THE INVENTION

During an emergency event such as a lock-down it may be necessary to quickly secure a room or building from an outside area. Often, in order to secure an area, the door is locked and barricaded with furniture or other heavy object located nearby. However, this approach may be time consuming as the barricade is placed in front of the door. Additionally, this method does not account for those situations where a person may need to be let back inside of the room if they were not present when the lock-down was issued.

### SUMMARY OF THE INVENTION

A supplemental locking system comprises a mountable bracket for a door, a deadbolt housing and a deadbolt. The deadbolt housing and deadbolt are quickly coupled with a locking bracket and the deadbolt is movable to a lock position in one easy and quick movement. The deadbolt housing and deadbolt are able to be stored separately from the locking bracket so that the door is unable to be inadvertently locked. Then in the event of a lockdown or other emergency where it is necessary to lock the door, it is easy to couple the deadbolt housing and deadbolt to the locking bracket and move the deadbolt to a lock position in order to secure the door from the inside.

In one aspect, a supplemental door locking system comprises a bracket configured to attach to a door, a deadbolt housing configured to removably couple with the bracket and a deadbolt movable within the deadbolt housing between a door lock position and a door unlock position. The deadbolt is slidably movable between the door lock position and the door unlock position. In some embodiments, the deadbolt is configured to couple with a strikeplate of a door frame in the lock position. In some embodiments, the bracket comprises a groove for removably receiving the deadbolt housing. The groove comprises a top wall, a bottom wall, and one or more side walls and the deadbolt housing slidably couples with the groove. In some embodiments, the door comprises a left-hand door. Alternatively, the door comprises a right-hand door. In some embodiments, the locking system is in addition to a keyed door lock of the door. In some of these embodiments, the keyed door lock is only lockable from the outside.

In another aspect, a keyless door lock comprises a mountable bracket and a deadbolt configured to removably couple with the mountable bracket, wherein the deadbolt is movable to a lock position in order to lock the door when the deadbolt is coupled with the mountable bracket. The deadbolt is slidably movable between the door lock position and the door unlock position. In some embodiments, the deadbolt is slidably movable within a deadbolt housing. In some embodiments, the deadbolt is configured to couple with a strikeplate of a door frame in the lock position. In some embodiments, the bracket comprises a groove for removably receiving the deadbolt housing. The groove comprises a top wall, a bottom wall, and one or more side walls and the deadbolt housing slidably couples with the groove. In some embodiments, the door comprises a left-hand door. Alternatively, the door comprises a right-hand door. In some embodiments, the locking system is in addition to a keyed door lock of the door. In some of these embodiments, the keyed door lock is only lockable from the outside.

In a further aspect, a method of securing a door comprises coupling a locking bracket to the door, removably coupling a deadbolt with the locking bracket, and moving the deadbolt to a lock position in order to secure the door. In some embodiments, the door comprises a keyed door lock. In some of these embodiments, the keyed door lock is only lockable from the outside. The deadbolt housing is slidably coupled with the locking bracket. In some embodiments, the deadbolt is slidably movable within a deadbolt housing. In some embodiments, the deadbolt is removably coupled with the locking bracket and the deadbolt is moved to the lock position in one fluid motion.

### BRIEF DESCRIPTION OF THE FIGURES

FIGS. 1A and 1B illustrate a bracket for a door lock in accordance with some embodiments.

FIGS. 2A and 2B illustrate a base for a deadbolt housing for a door lock in accordance with some embodiments.

FIG. 3 illustrates a deadbolt housing for a door lock in accordance with some embodiments.

FIG. 4 illustrates a deadbolt for a door lock in accordance with some embodiments.

FIG. 5 illustrates a door locking system in accordance with some embodiments.

FIG. 6 illustrates a supplemental door lock in accordance with some embodiments.

FIG. 7 illustrates a method of securing a door in accordance with some embodiments.

FIG. 8 illustrates a deadbolt for a door lock in accordance with some embodiments.

FIG. 9 illustrates a method of securing a door in accordance with some embodiments.

FIG. 10 illustrates a supplemental door locking system in accordance with some embodiments.

### DETAILED DESCRIPTION OF THE EMBODIMENTS

Embodiments of the invention are directed to a supplemental locking system. The locking system comprises a mountable bracket for a door, a deadbolt housing and a deadbolt. The deadbolt housing and deadbolt are quickly coupled with a locking bracket and the deadbolt is movable to a lock position in one easy and quick movement. The deadbolt housing and deadbolt are able to be stored separately from the locking bracket so that the door is unable to be inadvertently locked. Then in the event of a lockdown or other emergency where it is necessary to lock the door, it is easy to couple the deadbolt housing and deadbolt to the locking bracket and move the deadbolt to a lock position in order to secure the door from the inside.

Reference will now be made in detail to implementations of a supplemental locking system and method as illustrated in the accompanying drawings. In the interest of clarity, not all of the routine features of the implementations described herein are shown and described. It will also be appreciated that in the development of any such actual implementation, numerous implementation-specific decisions be made to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

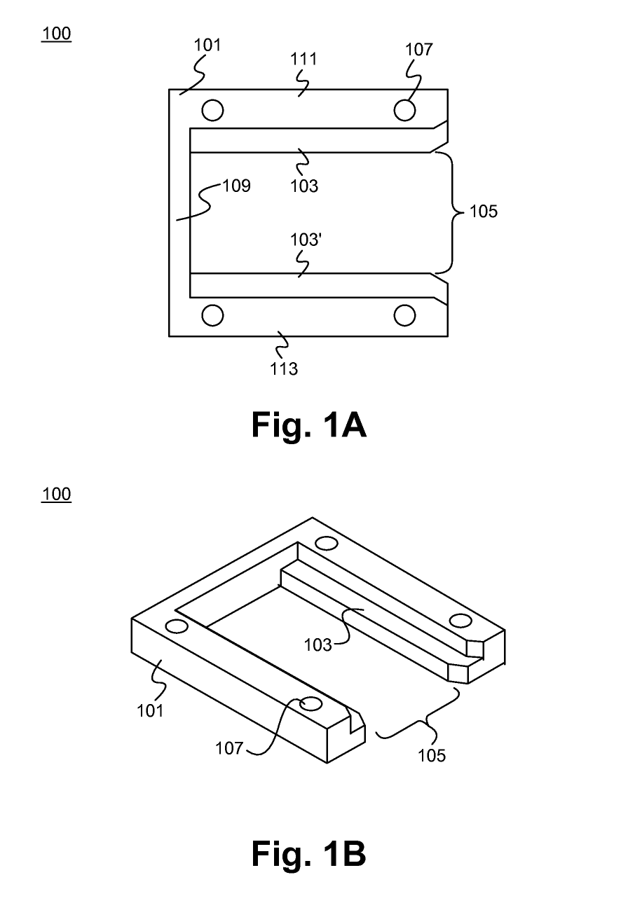

Referring now to FIG. 1A, a locking system bracket is depicted therein. The locking system bracket 100 comprises a body 101 comprising a top bracket arm 111, a bottom bracket arm 113 and one or more side bracket arms 109. As shown in FIG. 1A and particularly within FIG. 1B, the top bracket arm 111 comprises a first step 103 and the bottom bracket arm 113 comprises a step 103′ which creates a groove within the locking bracket 100. The groove comprises a groove opening 105. As further shown within FIGS. 1A and 1B, the bracket 100 comprises one or more mounting holes 107. The one or more mounting holes 107 enable the bracket to be mounted to a door. For example, in some embodiments, the one or more mounting holes 107 receive one of a nail and/or a screw for mounting the bracket 100 with a door.

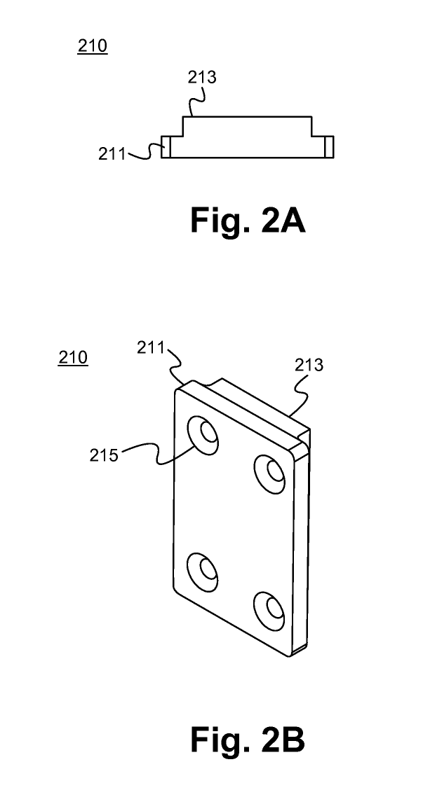

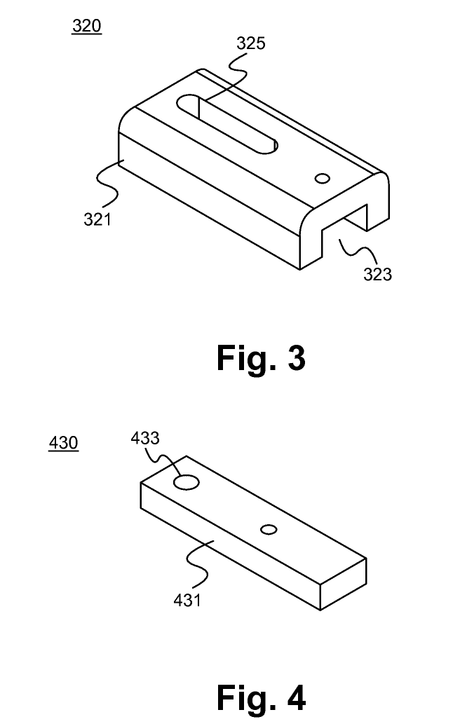

FIGS. 2A and 2B illustrate a base for a deadbolt housing for a door lock in accordance with some embodiments. The base 210 comprises a top side 213 and a bottom side 211 which extends out from the top side 213. The bottom side 211 is configured to couple with the groove opening 105 in order to slide within the groove and removably couple with the bracket 100, such as described above. In some embodiments, the base 210 comprises one or more mounting holes 215 for coupling the base 210 with a deadbolt housing 320 (FIG. 3). The base 210 is able to couple with the deadbolt housing 320 by any appropriate method as known in the art. For example, in some embodiments, the base 210 couples with the deadbolt housing 320 by one or more screws or other fasteners. Alternatively, in some embodiments, the base 210 non-removably couples with the deadbolt housing 320 and/or integrally attached to the deadbolt housing 320.

As shown in FIG. 3, the deadbolt housing 320 comprises a body 321 comprising a deadbolt opening 323 and an elongated groove 325 for moving a deadbolt 430 (FIG. 4) within the opening 323 of the housing 320.

FIG. 4 illustrates the deadbolt for a door lock in accordance with some embodiments. The deadbolt 430 comprises a deadbolt body 431 and a mounting hole 433 configured to accept a deadbolt knob for moving the deadbolt 430 within the deadbolt housing 320.

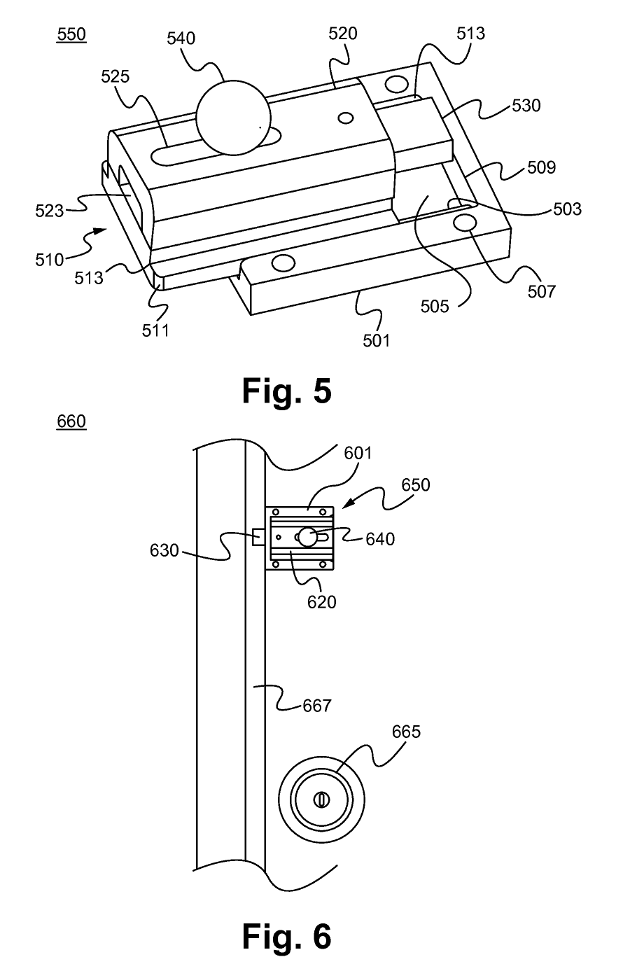

FIG. 5 illustrates a supplemental door locking system in an assembled configuration. The locking system 550 comprises a mounting bracket 600, a deadbolt housing 520 coupled to a base 510 and a deadbolt 530 located within an opening of the housing 520. The deadbolt housing 520 and the deadbolt 530 is separable from and able to removably couple with the groove of the bracket body 500. Particularly, the deadbolt housing 520 and deadbolt 530 are configured to couple with the groove of the bracket body 500, such as described above. As shown within FIG. 5, the bottom sides 511 of the base 510 fits on the first step 503 and the second step 503′ and allows the base 510 to easily slide into the groove opening 505. In some embodiments, the deadbolt housing 520 and deadbolt 530 are slid within the groove opening 505 until the deadbolt housing 520 contacts the side bracket arm 509.

When the deadbolt housing 520 and deadbolt 530 are coupled with the bracket body 500, the deadbolt 530 is movable within the deadbolt opening 523 by moving the deadbolt knob 540 forward and backwards within the elongated groove 525. In some embodiments, the deadbolt knob 540 is moved forward and toward the side bracket arm 509 in order to move the deadbolt to a lock position.

FIG. 6 illustrates a locking system 650 coupled with a door 660. The locking system is similar to the locking system 550, such as described above and comprises a mounting bracket 600, a deadbolt housing 620 and a deadbolt 630 located within an opening of the housing 620. In some embodiments, the mounting bracket 600 is coupled to the door 660 using one or more of screws and nails. In some embodiments, the deadbolt housing 620 and the deadbolt 630 are stored separately from the mounting bracket 600. For example, in some embodiments, the deadbolt housing 620 and the deadbolt 630 in a nearby drawer or a lockable container located near the door 660. As described above, the deadbolt housing 620 and deadbolt 630 are slid within the groove opening 606. Once the deadbolt housing 620 and the deadbolt 630 are coupled with the bracket 600, the deadbolt 630 is able to be moved into the lock position. In some embodiments, the deadbolt housing 620 and the deadbolt 630 slidably couple with the mounting bracket 600 in the same direction as the deadbolt 630 is moved within the deadbolt housing 620 and to the lock position. Consequently, the housing 620 and deadbolt 630 are able to slidably couple with the locking bracket 600 and the deadbolt 630 is locked in order to secure the door 660 in one fluid motion.

The deadbolt 630 is moved by moving the deadbolt knob 640 forward and backwards within the elongated groove. In some embodiments, the deadbolt knob 640 is moved forward toward a frame of the door 667 in order to move the deadbolt 630 to a lock position. In some embodiments, the deadbolt 630 couples with a strikeplate of the door frame 667, when the deadbolt 630 is in the lock position. Alternatively, in some embodiments, the deadbolt 630 covers an edge of the door frame 667 in the lock position where the deadbolt 630 prevents the door from being opened. In some embodiments, the locking system 650 couples to a left-hand door. Alternatively, in some embodiments, the locking system 650 is able to couple to a right-hand door. As shown within FIG. 6, the locking system 650 is in addition to a keyed lock of the door nob 665.

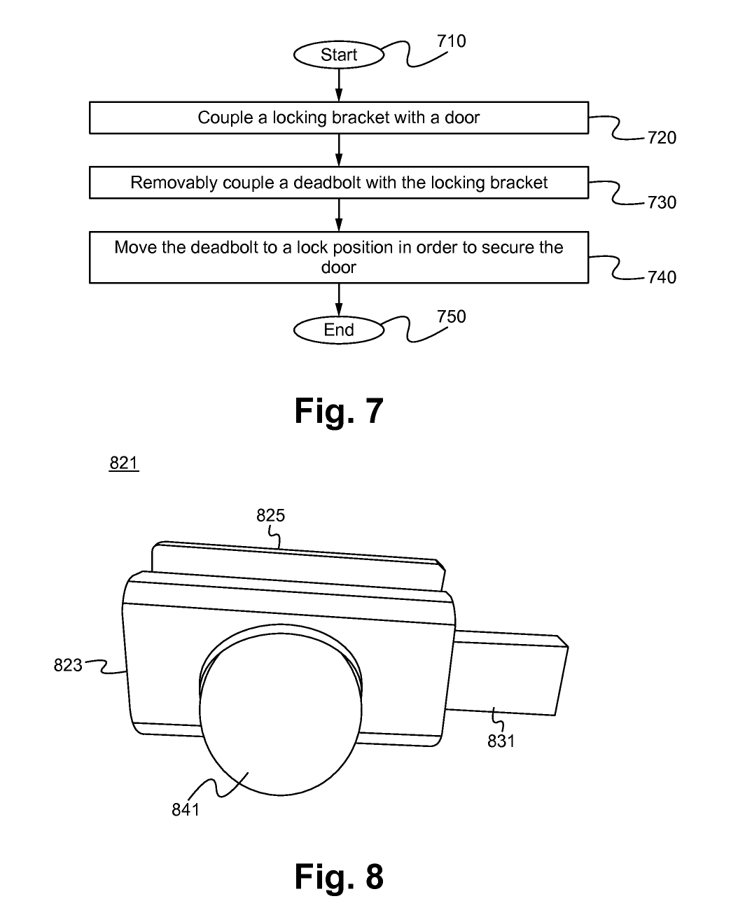

FIG. 7 illustrates a method of securing a door in accordance with some embodiments. The method begins in the step 710. In the step 720, a locking bracket is coupled with a door. In the step 730, a deadbolt is removably coupled with the locking bracket. In some embodiments, the deadbolt is slidably movable within a deadbolt housing which also couples with a locking bracket. In the step 740, the deadbolt is moved to a lock position in order to lock and secure the door. In some embodiments, the housing deadbolt slidably couple with the locking bracket and the deadbolt is locked in order to secure the door in one fluid motion. In some embodiments, the door comprises a keyed lock. In some embodiments, the keyed lock is only lockable from the outside.

FIG. 8 illustrates a deadbolt for a door lock in accordance with further embodiments. The deadbolt 821 comprises a deadbolt body 823, and a deadbolt knob 841 and a deadbolt arm 831. As shown within FIG. 8, the deadbolt arm 831 is fixedly connected to the deadbolt body 823. The deadbolt knob 841 is configured to move the deadbolt 823 back and forth within a mounting bracket such as described above. The deadbolt body 823 and the ledge 825 are configured to couple and slide within a groove opening of the mounting bracket.

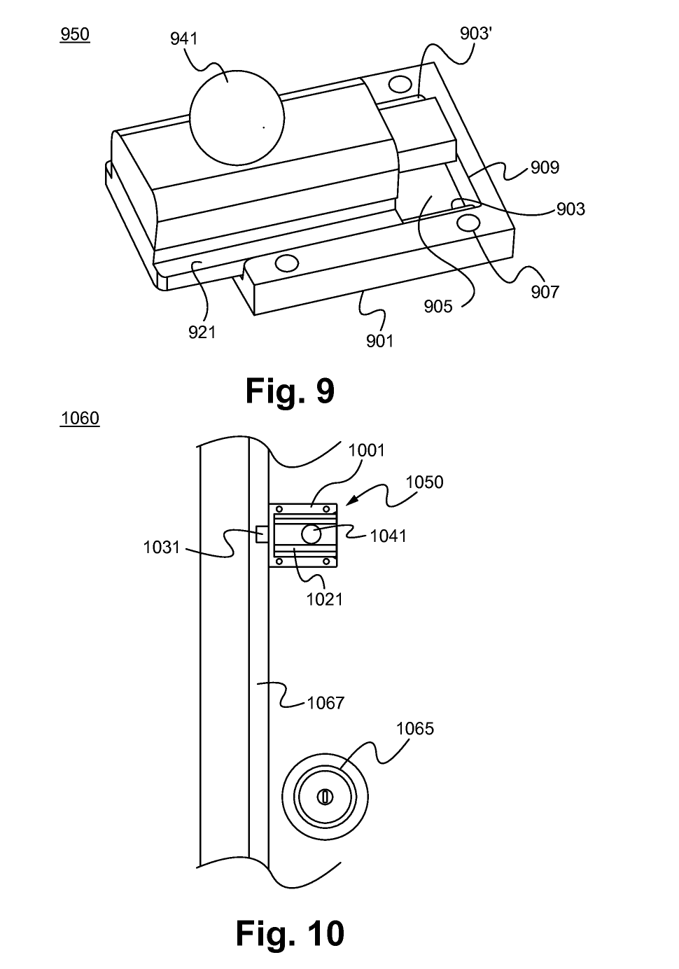

FIG. 9 illustrates a supplemental door locking system in an assembled configuration utilizing the deadbolt 821 such as described above. The locking system 950 comprises a mounting bracket 901 and a deadbolt 921. The deadbolt 921 is separable from and able to removably couple with the groove of the bracket body 901. Particularly, the deadbolt 921 is configured to couple with the groove of the bracket body 901, such as described above. As shown within FIG. 9, the deadbolt body 831 and the ledge 825 fit on the first step 903 and the second step 903′ and allow the deadbolt 921 to easily slide into the groove opening 905. In some embodiments, the deadbolt 921 is slid within the groove opening 905 until the deadbolt body 831 contacts the side bracket arm 909.

When the deadbolt 921 and deadbolt body 831 are coupled with the bracket body 901, the deadbolt knob 941 is moved forward and toward the side bracket arm 909 in order to move the deadbolt 921 to a lock position.

FIG. 10 illustrates a locking system 1050 coupled with a door 1060. The locking system is similar to the locking system 950, such as described above and comprises a mounting bracket 1000 and a deadbolt 1021. In some embodiments, the mounting bracket 1000 is coupled to the door 1060 using one or more of screws and nails. In some embodiments, the deadbolt 1021 is stored separately from the mounting bracket 1000. For example, in some embodiments, the deadbolt 1021 is stored in a nearby drawer or a lockable container located near the door 1060. As described above, the deadbolt 1021 is slid within the groove opening 1005. Once the deadbolt 1021, the deadbolt arm 1031 is able to be moved into the lock position. Consequently, the deadbolt 1021 is able to slidably couple with the locking bracket 1000 and the deadbolt arm 1031 is locked in order to secure the door 1060 in one fluid motion.

The deadbolt 1031 is moved by moving the deadbolt knob 1040 forward and backwards in order to move the deadbolt body 1021 within the groove. In some embodiments, the deadbolt knob 1041 is moved forward toward a frame of the door 1067 in order to move the deadbolt arm 1031 to a lock position. In some embodiments, the deadbolt arm 1031 couples with a strikeplate of the door frame 1067, when the deadbolt arm 1031 is in the lock position. Alternatively, in some embodiments, the deadbolt arm 1031 covers an edge of the door frame 1067 in the lock position where the deadbolt arm 1031 prevents the door from being opened. In some embodiments, the locking system 1050 couples to a left-hand door. Alternatively, in some embodiments, the locking system 1050 is able to couple to a right-hand door. As shown within FIG. 10, the locking system 1050 is in addition to a keyed lock of the door nob 1065.

In operation, the a deadbolt housing and deadbolt are quickly coupled with a locking bracket and the deadbolt is movable to a lock position in one easy and quick movement. The deadbolt housing and deadbolt are able to be stored separately from the locking bracket so that the door is unable to be inadvertently locked. Then in the event of a lockdown or other emergency where it is necessary to lock the door, it is easy to couple the deadbolt housing and deadbolt to the locking bracket and move the deadbolt to a lock position in order to secure the door from the inside. Additionally because the deadbolt housing and deadbolt may be stored separately from the door and locking bracket, it is assured that it is only accessible by the appropriate personnel.

Particularly, the present invention takes a unique and efficient approach to securing a door during an emergency or other lockdown event. This may be especially useful to schools, office parks, malls, and other areas where there may be a large amount of people dispersed throughout a variety of different rooms and areas. The supplemental locking system enables a user to quickly lock a door and secure a room without a key and in a manner that is undetectable from the outside. Additionally, because the system is keyless and does not require a physical blocking of the door, the door may be opened in those cases where a child or other person must reenter the room. Such as if the child or person was in the bathroom or other area when the emergency occurred. Accordingly, the supplemental locking system as described herein has many advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

We claim:

1. A supplemental door locking system comprising:
a. a bracket configured to attach to a door;
b. a deadbolt housing configured to removably couple with the bracket; and
c. a deadbolt movable within the deadbolt housing between a door lock position and a door unlock position.

2. The supplemental door locking system of claim 1, wherein the deadbolt is slidably movable between the door lock position and the door unlock position.

3. The supplemental door locking system of claim 1, wherein the deadbolt is configured to couple with a strikeplate of a door frame in the lock position.

4. The supplemental door locking system of claim 1, wherein the bracket comprises a groove for removably receiving the deadbolt housing.

5. The supplemental door locking system of claim 5, wherein the groove comprises a top wall, a bottom wall, and one or more side walls.

6. The supplemental door locking system of claim 5, wherein the deadbolt housing slidably couples with the groove.

7. The supplemental door locking system of claim 1, wherein the door comprises a left-hand door.

8. The supplemental door locking system of claim 1, wherein the door comprises a right-hand door.

9. The supplemental door locking system of claim 1, wherein the locking system is in addition to a keyed door lock of the door.

10. The supplemental door locking system of claim 9, wherein the keyed door lock is only lockable from the outside.

11. A keyless door lock comprising:
a. a mountable bracket; and
b. a deadbolt configured to removably couple with the mountable bracket, wherein the deadbolt is movable to a lock position in order to lock the door when the deadbolt is coupled with the mountable bracket.

12. The keyless door lock of claim 11, wherein the deadbolt is slidably movable between the door lock position and the door unlock position.

13. The keyless door lock of claim 11, wherein the deadbolt is slidably movable within a deadbolt housing.

14. The keyless door lock of claim 11, wherein the deadbolt is configured to couple with a strikeplate of a door frame in the lock position.

15. The keyless door lock of claim 11, wherein the bracket comprises a groove for removably receiving a deadbolt housing.

16. The keyless door lock of claim 15, wherein the groove comprises a top wall, a bottom wall, and one or more side walls.

17. The keyless door lock of claim 11, wherein the door comprises a left-hand door.

18. The keyless door lock of claim 11, wherein the door comprises a right-hand door.

19. The keyless door lock of claim 11, wherein the door lock is in addition to a keyed door lock of the door.

20. The keyless door lock of claim 18, wherein the keyed door lock is only lockable from the outside.

21. A method of securing a door comprising:
a. coupling a locking bracket to the door;
b. removably coupling a deadbolt with the locking bracket; and
c. moving the deadbolt to a lock position in order to secure the door.

22. The method of claim 21, wherein the door comprises a keyed door lock.

23. The method of claim 22, wherein the keyed door lock is only lockable from the outside.

24. The method of claim 21, wherein the deadbolt is slidably coupled with the locking bracket.

25. The method of claim 21, wherein the deadbolt is slidably movable within a deadbolt housing.

26. The method of claim 21, wherein the deadbolt is removably coupled with the locking bracket and the deadbolt is moved to the lock position in one fluid motion.
